(19) United States
(12) Patent Application Publication
(10) Pub. No.: US 2018/0030285 A1
(43) Pub. Date: Feb. 1, 2018

(54) COATED ARTICLES AND METHODS FOR MAKING SAME

(71) Applicant: 3M INNOVATIVE PROPERTIES COMPANY, St. Paul, MN (US)

(72) Inventors: Erik D. Olson, St. Louis Park, MN (US); Molly J. Smith, Hudson, WI (US)

(21) Appl. No.: 15/540,272

(22) PCT Filed: Dec. 16, 2015
(86) PCT No.: PCT/US2015/066077

§ 371 Date: Jun. 28, 2017

Related U.S. Application Data
(60) Provisional application No. 62/097,239, filed on Dec. 29, 2014.

(30) Foreign Application Priority Data
Dec. 29, 2014 (US) 62097239

(51) Int. Cl. C09D 5/16; G02B 1/18; C09D 171/00; G06F 3/041

(52) U.S. Cl. CPC C09D 5/1662; C09D 171/00; G02B 1/18; G06F 3/041

(57) ABSTRACT

A coated article includes a substrate having a major surface comprising sapphire, and a coating disposed on the major surface. The coating includes a fluorinated polymer bonded to the major surface, the fluorinated polymer having the following general formula (I).

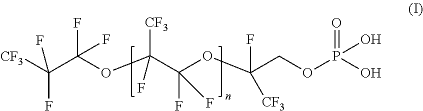

### FIELD

The present disclosure relates to substrates beating a coating, and methods of making the same.

### BACKGROUND

Various oleophobic coatings have been introduced for use on substrates. Such coatings are described in, for example, in U.S. App. Pub. 2011/0129665 and EP App. Pub. 1300433.

### SUMMARY

In some embodiments, a coated article is provided. The coated article includes a substrate having a major surface comprising sapphire, and a coating disposed on the major surface. The coating includes a fluorinated polymer bonded to the major surface, the fluorinated polymer having the following general formula (I)

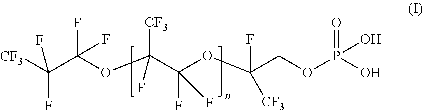

In some embodiments, an electronic device is provided. The electronic device includes a touch-sensitive user input device. The touch-sensitive user input screen includes the above-described coated article.

The above summary of the present disclosure is not intended to describe each embodiment of the present disclosure. The details of one or more embodiments of the disclosure are also set forth in the description below. Other features, objects, and advantages of the disclosure will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 is a perspective view of an electronic device that may have a surface bearing the coatings of the present disclosure.

FIG. 2 is a cross-sectional view of a substrate bearing a coating in accordance with some embodiments of the present disclosure.

FIG. 3 is a plot of static water contact angle as a function of abrasive cycles for Example 1 and Comparative Examples 1 and 2.

FIG. 4 is a plot of static hexadecane contact angle as a function of abrasive cycles for Example 1 and Comparative Examples 1 and 2.

### DETAILED DESCRIPTION

Electronic devices may include a multitude of different touch-sensitive input devices (e.g, displays, track pads, keyboards). In use, oils and other contaminants that are introduced onto the input surface of the touch-sensitive device may adversely affect appearance and performance, particularly where information is also displayed on the touch-sensitive device. To mitigate this problem, a number of different surface treatments have been employed, depending on substrate design and desired composition. In the case of sapphire substrates, oleophopic coatings (e.g., silane functional oleophobic coatings) have been employed. However, given that sapphire is a highly inert surface, it has been required that an intermediate, or transition layer be deposited between the sapphire and the oleophobic coating in order to produce a sufficiently durable coating. While such coatings can be durable and provide the desired performance, the requirement of an additional layer (the transition layer), which is typically deposited by chemical vapor deposition or other similar deposition techniques, adds additional processing complexity to the manufacturing process. Consequently, oleophobic coatings that could perform as well as known coatings, but be deposited directly onto the sapphire without the need for a transition layer, are desirable.

As used herein, it should be understood that when a layer (or coating) is said to be “formed on” or “disposed on” another layer (or substrate), the layers are understood to be generally parallel to one another, but there may be intervening layers formed or disposed between those layers. In contrast, “disposed directly on” or “formed directly on” refers to layers (or a layer and a substrate) in direct contact with one another, with no intervening layers (other than possibly a native oxide layer).

As used herein, the term “oleophobic” refers to a material (e.g., in the form of a coating) that repels or tends not to combine with oil or grease and that, when deposited onto a substrate, forms a surface that generates a static contact angle with n-hexadecane of at least 30°, at least 35°, or at least 40° measured after drying and curing of the coating.

As used herein, the term “hydrophobic” refers to a material (e.g., in the form of a coating) that repels or tends not to combine with water and that, when deposited onto a substrate, forms a surface that generates a static contact angle with water of greater than 70° or greater than 90° with water.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Generally, the present application relates to surface coatings for use on substrates useful in the electronics industry. More specifically, the present disclosure relates to oleophobic coatings and other surface coatings for sapphire substrates useful as components touch-sensitive input devices for electronic devices (e.g., mobile phones and portable computing devices).

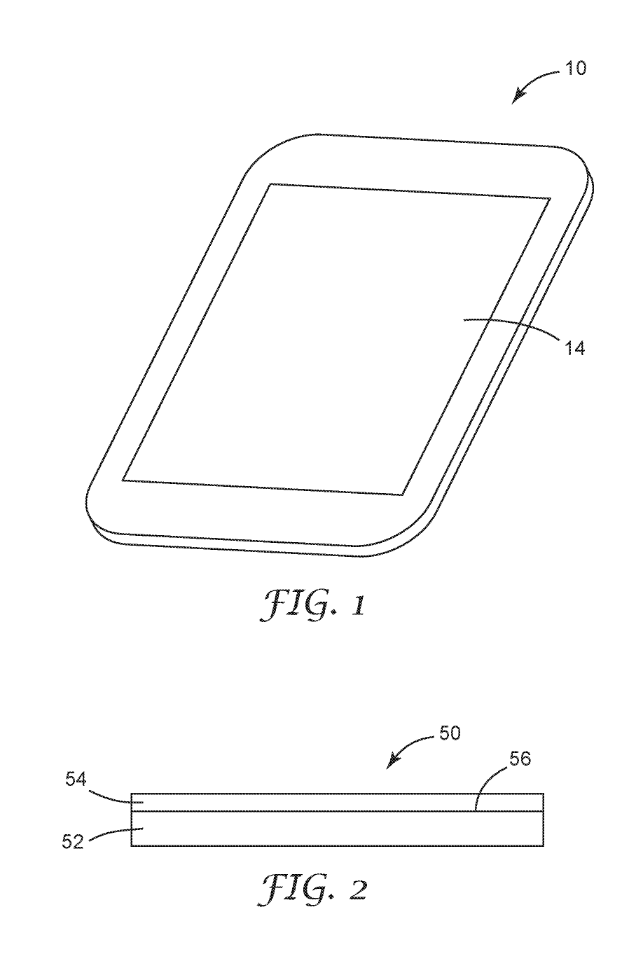

FIG. 1 is a perspective view of electronic device 10, for example a mobile phone, tablet computer, or other electronic device, having a touch-sensitive input device 12 incorporated therein. The touch-sensitive device may include a suitable transparent or translucent material, for example, a transparent crystalline material such as sapphire or sapphire glass. As will be appreciated by those skilled in the art, the touch-sensitive input device 12 may be configured to recognize user input by manipulating virtual objects displayed on the device, sensing touches, and the like. In some embodiments, to reduce the presence of contaminants, oils, and other deposits, an oleophobic coating may be deposited onto an external (i.e., user facing) major surface of the input device 12.

Referring now to FIG. 2, a schematic cross-sectional view of a coated article 50 that includes a substrate 52 and a coating 54 disposed on a first major surface 56 of the substrate 52 is provided. For example, the coated article 50 may be useful as a component (e.g., a window, cover glass, touch-sensitive screen, or the like) in a touch-sensitive input device for a mobile phone, tablet computer, or other electronic device.

The substrate 52 may include (or be formed of) a sapphire or sapphire glass material, for example an aluminum oxide or alumina (Al₂O₃ or α-Al₂O₃) material. While suitable sapphire materials may be found naturally, substrate 52 may also be formed of a synthetic sapphire material, for example by sintering and fusing aluminum oxide, hot isostatic pressing, and processing the resulting polycrystalline product to form a substantially single-crystal sapphire material. The substrate 52 may have a thickness (i.e., dimension of the substrate in a direction that is normal to the first major surface 56) of between 1.1 mm and 5 mm, between 0.2 mm and 1.5 mm, or between 0.2 mm and 0.8 mm. Alternatively, the substrate may be formed of two or more layers or materials. In such embodiments, at least one outer-most/external layer of the multi-layered substrate may include (or be formed of) a sapphire or sapphire glass material, for example an aluminum oxide or alumina (Al₂O₃ or α-Al₂O₃) material.

In some embodiments, the coating 54 may include (or be formed of) a fluorinated material. In some embodiments, the coating 54 may include (or be formed of) a fluorinated polymer that is bonded to the surface 56 of the substrate 52. The bond may be achieved through coordination attachment, covalent attachment, intermolecular forces such as van der Waals, dipole-dipole, ion dipole, hydrogen bonding, or a combination thereof. In some embodiments, the bond may be formed between the fluorinated polymer and one or more active sites on the surface 56 of the substrate 52.

In some embodiments, the fluorinated polymer may have the following general formula (I):

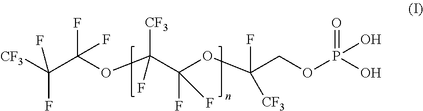

In some embodiments, the fluorinated polymer having general formula (I) may include those fluorinated polymers in which n ranges from 1-120 or 20-120. In some embodiments, the fluorinated polymer having general formula (I) may include those fluorinated polymers having a number average molecular weight (Mₙ) of 3,000-15,000, 4,000-12,000, 5,000-10,000, or 6,000-8,000 daltons.

In any of the above described embodiments, the coating may be oleophobic and/or hydrophobic. In some embodiments, the coating 54 may be disposed on any portion, up to the entirety, of the first major surface 56. The coating 54 may be disposed directly on the first major surface 56. The coating 54 may have a thickness (i.e., dimension of the coating in a direction that is normal to the first major surface 56) of between 0.1 nm and 20 nm or between 0.5 nm and 5 nm. It is believed that the coating 54 may be disposed as a monolayer on the substrate major surface 56, such that the phosphate groups are bonded to said surface.

In some embodiments, in addition to the coating 54, one or more additional coatings may be disposed on either or both of the first major surface 56 or the second major surface 58 of the substrate 52. For example, one or more optical coatings, scratch-resistant coatings, anti-reflective coatings, anti-glare coatings, or combinations thereof may also be disposed on the substrate.

The present disclosure further relates to methods of making the above-described coated articles. In some embodiments, a major surface of the substrate may be subjected to one or more surface preparation processes such as cleaning with water or a chemical solvent, heat treatment, polishing, other surface preparation process, or combinations thereof.

In some embodiments, the fluorinated polymer may then be deposited onto the prepared major surface of the substrate to form the coated article. In some embodiments, the fluorinated polymer may be deposited in the form of a solution that includes a solvent and the fluorinated polymer. Suitable solvents include fluorinated fluids, such as hydrofluoroethers. Suitable deposition techniques for the fluorinated polymer (or solvent containing the fluorinated polymer) include physical or chemical vapor deposition, spray coating, dip coating, wipe coating, spin coating, or other known material deposition processes. Following deposition of the fluorinated material, optionally, any remaining solvent may be removed from the substrate. Finally, the coated substrate may be subjected to a curing process to form the coated article. As will be understood by those skilled in the art, the curing process is intended to facilitate bonding of the fluorinated polymer to the substrate. Any conventional curing technique may be employed, such as by exposing the coated substrate to air at about room temperature or greater for a sufficient period.

The operation of the present disclosure will be further described with regard to the following detailed examples. These examples are offered to further illustrate various specific embodiments and techniques. It should be understood, however, that many variations and modifications may be made while remaining within the scope of the present disclosure.

### Examples

### Preparation of Hexafluoropropylene Oxide-Methyl Ester Mₙ 7000 Daltons

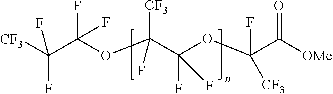

To a 3 L round bottom flask equipped with an overhead stirrer, condenser, heating mantel and temperature probe, was added 1460 g (243.3 mmoles, 1 eq) of KRYTOX 157 FSH (available from Dupont, Wilmington Del.), 1278 g of NOVEC 7300 (available from 3M Company), and 123.5 g (973.3 mmoles, 4 eq) of oxalyl chloride (available from Alpha Aesar). The mixture was heated 65° C.-70° C. (reflux oxalyl chloride) for 2 hours and then to 85° C. for one hour. The mixture was then heated to 100° C. to distill off the oxalyl chloride. The reaction mixture was cooled to approximately 20° C. and 311.9 g of methanol was added. This caused some effervescence but not an exotherm. This mixture was stirred overnight at 50° C. The bottom phase was separated and concentrated in vacuo to give 1568 grams of 7000 dalton HFPO-methyl ester as confirmed by H1, F19 and C13 NMR analysis. This material was used in the next step.

### Preparation of Hexafluoropropylene Oxide-Alcohol Mₙ 7000 Daltons

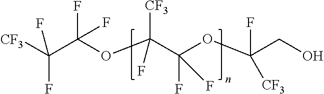

To a 3 L 4 necked flask equipped with an overhead stirrer and water bath was added 37.7 g (997.7 mmoles, 4 eq) of sodium borohydride (available Alpha Aesar) and 434.8 g of tetrahydrofuran. The mixture was cooled to 0° C. for 15 minutes and then treated with a premix of 1500 g (249.4 mmoles, 1 eq) of hexafluoropropylene oxide methyl ester dissolved in 2500 g (7141 mmoles, 28.6 eq) of NOVEC 7300. The temperature rose to 10° C. and gas was evolved. The mixture was then cooled to 5° C. and 127.9 g of methanol was added slowly over a period of 5 hours keeping the temperature below 10° C. The reaction was then allowed to warm to room temperature overnight. The mixture was cooled to 5° C. and 128 g of methanol was followed by 185 g of acetic acid. After 10 minutes, 1500 mL of water was added to the mixture. The mixture was phase split for 30 minutes and the bottom organic phase was washed with 1500 mL of water. The bottom organic phase water was stripped to give 1442 grams of the desired product, a hazy oil. This material was used in the next step without further purification.

### Preparation of Hexafluoropropylene Oxide-Phosphate Ester Mₙ 7000 Daltons

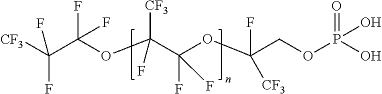

300 g of a 33.3 wt % solution of hexafluoropropylene oxide-alcohol 7000 daltons (16.7 mmoles, 1 eq;) in NOVEC 7200 (available from 3M Company, St Paul Minn.) was cooled to 5° C. and 5.11 g (33.3 mmoles, 2 eq) of phosphorus oxychloride (available from Alph Aesar) was added. To this was added 3.37 g (33.3 mmoles, 2 eq) of triethylamine (available from Aldrich). This mixture was stirred and allowed to warm to room temperature for 4 hours and then quenched with 100 g of water and stirred overnight. To this mixture was added 100.1 g of tetrahydrofuran and 161.1 g of NOVEC 7200 and then allowed to phase split for 30 minutes. The bottom layer was clear and the top layer was cloudy. The bottom layer was separated and to the top layer was added 100 g of tetrahydrofuran, 80 g of NOVEC 7200, and 67.47 g of a 26.5 wt % solution of sodium chloride in water. This gave three phases. The top and bottom was clear and the middle was cloudy. This was allowed to split for 30 minutes and the bottom phase was added to the previous bottom phase. To the top phase was added 80.54 g of NOVEC 7200 and the mixture was allowed to split for 30 minutes and the bottom phase was added to the previous bottom phase. The combined bottom phases were concentrated in vacuo to give 65 grams of hexafluoropropylene oxide-phosphate ester (HFPO-phosphate ester; Mₙ 7000 daltons) at 90% purity as determined by H1, F19, C13, and P39 NMR. A 0.1 wt % coating solution of 7000 daltons HFPO-phosphate ester was prepared by diluting the HFPO-phosphate ester in the appropriate amount of NOVEC 7200.

### Coating and Evaluation

Coating substrates (sapphire glass 2.54 cm×10.16 cm×1.00 mm or CORNING GORILLA GLASS 5.08 cm×10.16 cm×1.00 mm) were obtained from Abrisa Technologies, Santa Paula, Calif. The coating substrates were cleaned by soaking for 1 minute in a 0.5M NaOH solution, rinsing with deionized water followed by an isopropyl alcohol rinse. The cleaned substrates were then spray coated with a coating solution using a bench-top automatic sprayer (PVA model 350 with a FCS300R Spray Valve) with a 6 mL/min flow and translating the nozzle across the substrate at 50 mm/second. The material pressure on the automated sprayer was 7 psi, the atomizing pressure was 4-4.5 psi, the nozzle height from the substrate was 13 cm-14 cm, the area spacing was 10 cm, and the stroke was 0.0022 inches. The coating solutions included the 0.1% HFPO-phosphate ester described above as well as the silane based coating NOVEC 2202 (available from 3M Company, St Paul, Minn.). The coated substrates were cured for 1 hour at 185° C. These samples are outlined in Table 1 below.

TABLE 1

| Example | Coating Solution | Substrate |
|---|---|---|
| Example 1 | 0.1% HFPO-phosphate ester | Sapphire Glass |
| Comparative 1 | NOVEC 2202 | Sapphire Glass |
| Comparative 2 | NOVEC 2202 | GORILLA GLASS |

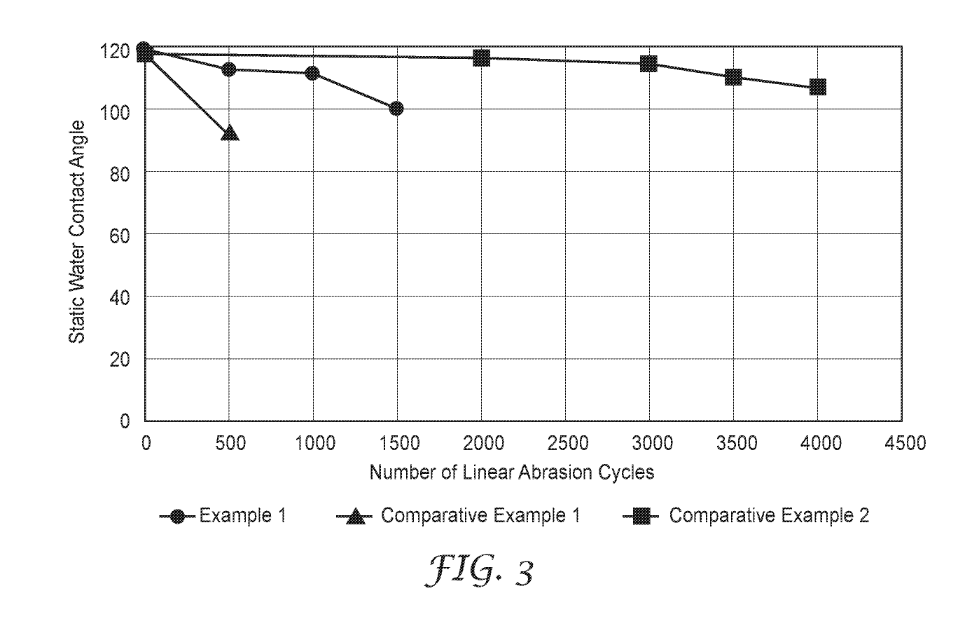

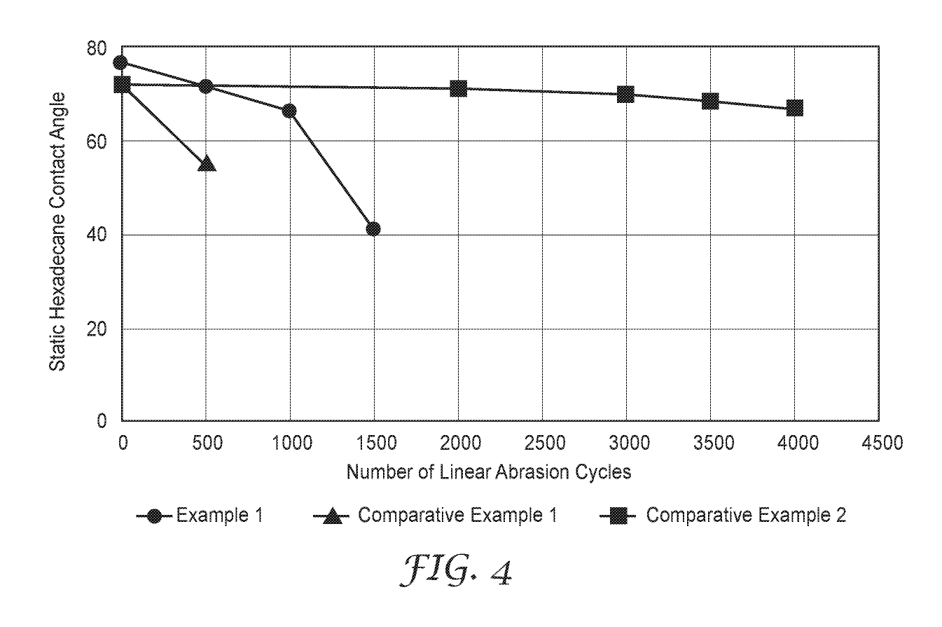

Samples were evaluated for durability and wear resistance using a TABER Model 5900 Abrader (TABER Industries, North Tonawanda, N.Y.). The coated substrates were fixed to a reciprocating table and cycled under an arm which held a piece of (#0000) steel wool in contact with the coated substrate under 10N normal force. Static water and hexadecane contact angles were measured periodically on the abrasion track of each sample using a KRUSS DSA100 goniometer. The tests were deemed complete when the static water contact angle was less than 100° or static hexadecane contact angle was less than 40°. The static water and hexadecane contact angles as a function of abrasion cycle are shown in FIGS. 3 and 4 below. These results surprisingly show that the HFPO-phosphate ester has good adhesion to sapphire glass.

1. An article comprising:
a substrate having a major surface comprising sapphire; and
a coating disposed on the major surface, wherein the coating comprises a fluorinated polymer bonded to the major surface;
wherein the fluorinated polymer has the following general formula (1) 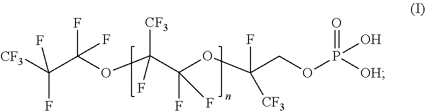
and
wherein the coating is disposed directly on the major surface.

2. (canceled)

3. The article of any one of claim 1, wherein the fluorinated polymer has a Mn of 3,000-15,000 daltons.

4. The article of any one of claim 1, wherein the fluorinated polymer includes polymers having values of n ranging from 20-120.

5. The article of any one of claim 1, wherein the coating is oleophobic.

6. The article of any one of claim 1, wherein the coating is hydrophobic.

7. An electronic device comprising:
a touch-sensitive user input device;
wherein the touch-sensitive user input screen comprises the coated article of claim 1.
